(19) United States
(12) Patent Application Publication
(10) Pub. No.: US 2016/0282498 A1
(43) Pub. Date: Sep. 29, 2016

(54) APPARATUS AND METHOD FOR CALCULATING EARTH'S POLARIZATION PROPERTIES FROM AIRBORNE TIME-DOMAIN ELECTROMAGNETIC DATA

(71) Applicant: CGG SERVICES SA, Massy Cedex (FR)

(72) Inventors: Tianyou CHEN, Mississauga (CA); Greg HODGES, Mississauga (CA); Adam SMIAROWSKI, Toronto (CA)

(21) Appl. No.: 14/969,684

(22) Filed: Dec. 15, 2015

Related U.S. Application Data
(60) Provisional application No. 62/138,998, filed on Mar. 27, 2015.

(51) Int. Cl. G01V 3/10; G01V 3/38

(52) U.S. Cl. CPC G01V 3/10; G01V 3/38

(57) ABSTRACT

A device and method for estimating an apparent chargeability of a surveyed underground formation. The method includes receiving a total response of the underground formation from an airborne time domain electromagnetic (TDEM) survey system; separating, in two stages, the total response into an inductive response and an induced polarization response; and calculating (308) the apparent chargeability based on the induced polarization response.

### CROSS-REFERENCE TO RELATED APPLICATIONS

This application claims priority and benefit from U.S. Provisional Patent Application No. 62/138,998, filed on Mar. 27, 2015, the entire disclosure of which is incorporated herein by reference.

### BACKGROUND

1. Technical Field

Embodiments of the subject matter disclosed herein generally relate to methods and systems for measuring earth's polarization properties from time-domain electromagnetic (TDEM) data and, more particularly, to mechanisms and techniques for detecting chargeable material underground and/or estimating induced polarization (IP) underground.

2. Discussion of the Background

EM surveying is a method of geophysical exploration to determine the properties of a portion of the earth's subsurface, information that is especially helpful in the oil and gas industry and the mining industry as well as having application toward the geotechnical and environmental industries. EM surveys may be based on a controlled source that sends EM energy waves into the earth, which induces eddy currents in the earth. The eddy currents generate a secondary EM field or ground response. By measuring the secondary field with an EM receiver, it is possible to estimate the depth and/or composition of the subsurface features. These features may be associated with a wide range of geologic structure or rock types, including subterranean hydrocarbon deposits and mineral deposits.

For an airborne TDEM survey system 100, as illustrated in FIG. 1, an airborne transmitter 102 applies a time-varying current to a coil, which generates a time-varying magnetic field 104. Time-varying magnetic field 104, when entering the ground 106, according to Faraday's Law, induces an electromotive force 108 (emf, or potential) and an electric field 110 in the ground. The induced potential causes a current 112 to flow in the ground 106. The current 112 and electric field 110 diffuse (in most geologic situations) laterally outward and vertically downward. Due to the resistive nature of the ground, the current 112 and electric field 110 decay in amplitude. The secondary magnetic field 114 associated with these currents is sensed by a receiver 116 or, the time-variation of the magnetic field is sensed by a receiver 116. Transmitter 102 and receiver 116 may be connected to an aircraft 118 so that a large area of the ground is swept.

In most EM systems, an induction response is the response from a layered earth containing conductive material and is typically defined to have a positive polarity as measured by a vertical coil receiver. An induced polarization response opposes the inductive response, i.e., it has opposite polarity. Historically, the IP response has been identified only when the measured total response is negative. However, if the IP response is small at all measurement times compared to the induction response, the measured total response will not become negative and the IP response may not be identified. Herein, the inductive response is considered as being “normal”, and the IP response is considered as being reversed or having opposite polarity to the inductive response.

For the majority of EM surveys, the secondary magnetic field or its time variation is the desired measurement quantity. If the secondary magnetic field or its time variation is plotted versus time, a decaying exponential 200 as illustrated in FIG. 2 is obtained. The IP effect is usually small, and barely visible in such a graph. The IP effect can be described by a positive exponential. When strong, the IP effect alters exponential 200, which appears as curve 202. Curve 202 shows a first region 204 where the induction dominates (it has positive polarity), a second region 206 of transitioning from the induction to the polarization effect, and a third region 208 of IP dominance (it has negative polarity). The IP effect can be viewed as a signal or response that opposes that of the induction response.

In the past, the IP effect has been mainly treated as noise, and thus, removed during processing. However, the IP effect may be indicative of the presence of minerals or oil and gas deposits or other rock types or other geologic features of interest. Thus, there is a need to detect and estimate/calculate the IP effect in underground regions.

While the IP effect for ground surveying has been studied for some time as disclosed, for example, in U.S. Pat. No. 3,967,190, the IP effect as measured by airborne TDEM surveys has not reached widespread application in the industry. Methods for processing the airborne TDEM data to extract the IP response and derive the polarization parameters (such as apparent chargeability and polarization time constant) include 1) an inversion algorithm (Beran et al, 2008, Estimation of Cole-Cole parameters from time-domain electromagnetic data: SEG, Las Vegas, 2008 Annual meeting, pp. 569-673), 2) a decay curve fitting algorithm (Kratzer et al, 2012, Induced polarization in airborne EM: Geophysics, 77, 317-327), and 3) a voltage ratio presentation (Smith et al, 1996, A special circumstance of airborne induced-polarization measurements: Geophysics, 61, 66-73)

However, the determination of polarization properties using inversion of airborne survey time-domain data is an underdetermined problem, and the polarization properties cannot be reliably estimated using the inversion method. The decay curve fitting algorithm presents a method which attempts to fit the measured decay curve using both inductive decays (representing the inductive response from conductive material) and induced polarization decays (representing the IP response). Again, obtaining stable polarization properties can be difficult because of the underdetermined nature of the problem. The last algorithm (the voltage ratio presentation) estimates the chargeability by identifying the IP response and normalizing it by the primary field.

Thus, there is a need to develop new methods for processing the airborne TDEM data for deriving the polarization properties.

### SUMMARY

One or more of the embodiments discussed herein illustrate how to estimate the IP effect from airborne TDEM data.

According to one embodiment, there is a method for estimating an apparent chargeability of a surveyed underground formation. The method includes receiving a total response of the underground formation from an airborne time domain electromagnetic (TDEM) survey system; separating, in two stages, the total response into an inductive response and an induced polarization response; and calculating the apparent chargeability based on the induced polarization response.

According to another embodiment, there is a computing device for estimating a chargeability of an underground formation. The computing device includes an interface that receives a total response of the underground formation from an airborne time domain electromagnetic survey system, and a processor connected to the interface. The processor is configured to receive a total response of the underground formation from an airborne time domain electromagnetic (TDEM) survey system; separate, in two stages, the total response into an inductive response and an induced polarization response; and calculate the apparent chargeability based on the induced polarization response.

According to yet another embodiment, there is a method for identifying a chargeability of an underground formation. The method includes receiving a total response of the underground formation from an airborne time domain electromagnetic (TDEM) survey system; calculating a decay curve associated with the total response; and calculating a quantity associated with the decay curve that indicates a presence of the chargeability of the underground formation.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of an EM acquisition system;

FIG. 2 illustrates decay curves measured with a receiver during an airborne TDEM survey;

FIG. 3 is a flowchart of a method for calculating a chargeability of a polarizable underground formation;

FIG. 4 illustrates the components of the signal, separated during the process of calculating the apparent chargeability of the underground formation;

FIG. 5 illustrates a transition from an induction response to an induced polarization response during an airborne TDEM survey;

FIG. 6 illustrates a method of measuring the induced polarization by calculating the time-integral of various portions of the measured signal;

FIG. 7 is another flowchart of a method for calculating the chargeability of a polarizable underground formation;

FIG. 8 is a flowchart of a method for identifying the existence of chargeable/polarizable bodies in an underground formation; and

FIG. 9 is a schematic illustration of a computing device.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

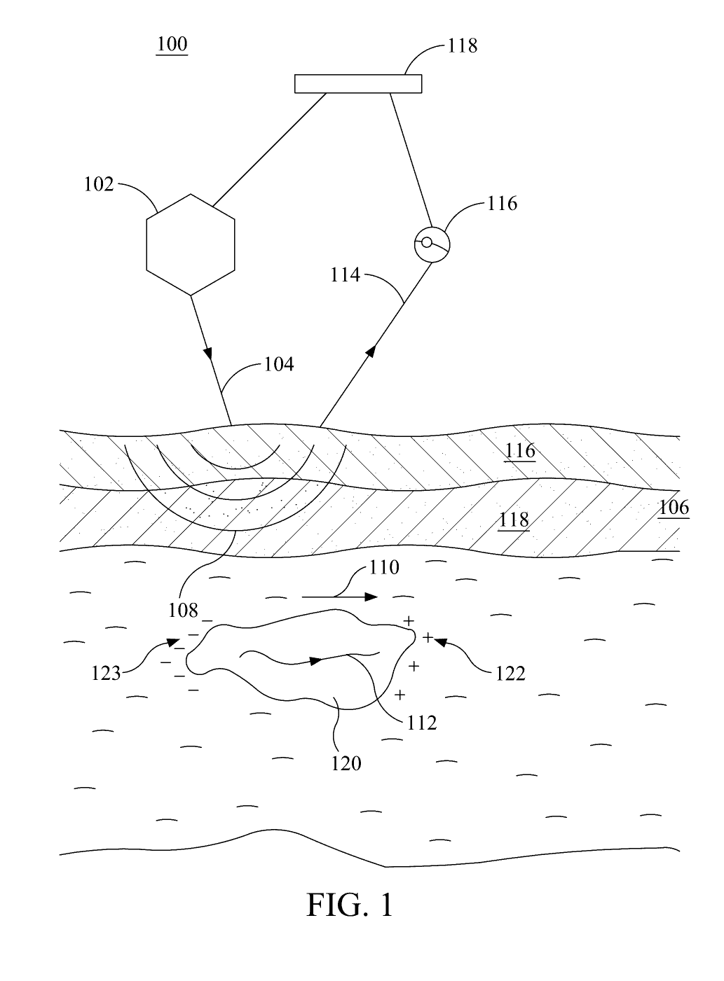

Before discussing the new methods for estimating the chargeability from airborne TDEM data, the generation of the IP effect is briefly discussed. In areas with chargeable subsurface regions 120, as illustrated in FIG. 1, two mechanisms contribute to the polarization of these regions: (1) the generated electric field 110 causes charge build-up 122 and 123 in some regions via polarization, and (2) the currents 112 induced in the ground may accumulate charge across the chargeable region 120. As the electric field and induced currents decrease in amplitude and diffuse away from the polarizable region, the charge accumulation 122 and 123 cannot be maintained and the charges move to neutralize the induced potentials. The induced polarization response is the field resulting from these charges (or the movement of these charges).

The IP effect has been studied for ground surveys as disclosed, for example, in U.S. Pat. No. 3,967,190. However, the IP effect from airborne TDEM differs significantly from ground IP. Aside from the differences in terms of survey execution and data processing, the physics behind the generation of the excitation signal and the resultant IP effect is different.

For example, in ground IP, an excitation voltage is applied across grounded electrodes, which generates an electric field which causes a current to flow in the ground. A secondary voltage is measured using two receiver electrodes. In polarizable regions, the electric charges accumulate across the region due to the current flow. When the excitation voltage is turned off, the electric charges cause a secondary voltage and electric field to be present. The electric charges move according to the secondary electric field, resulting in a decaying voltage potential, which can be measured by the receivers. This decaying voltage potential constitutes the ground IP response. A chargeability of the polarizable region is calculated by taking the ratio of (1) the secondary voltage when the excitation voltage is off and (2) the primary voltage (the voltage measured while the excitation voltage is on).

The IP response can be calculated/estimated by measuring the electric field of the charges, or by measuring the magnetic field caused by the movement of the charges, which can be sensed by a magnetic field receiver, or by sensing the time variation of the magnetic fields using a dB/dt (induction coil) sensor.

To summarize, the airborne method differs from the ground method in that the method of generating the electric field and current in the ground differs (inductively vs. direct current injection) and in how the induced polarization effect is measured (dB/dt or B-field or capacitively coupled E-field in the case of airborne, versus grounded potential in the ground case). Accordingly, the chargeability calculations developed for the ground IP need to be adjusted/updated for airborne application as now discussed.

### Two-Stage Decay Fitting Algorithm

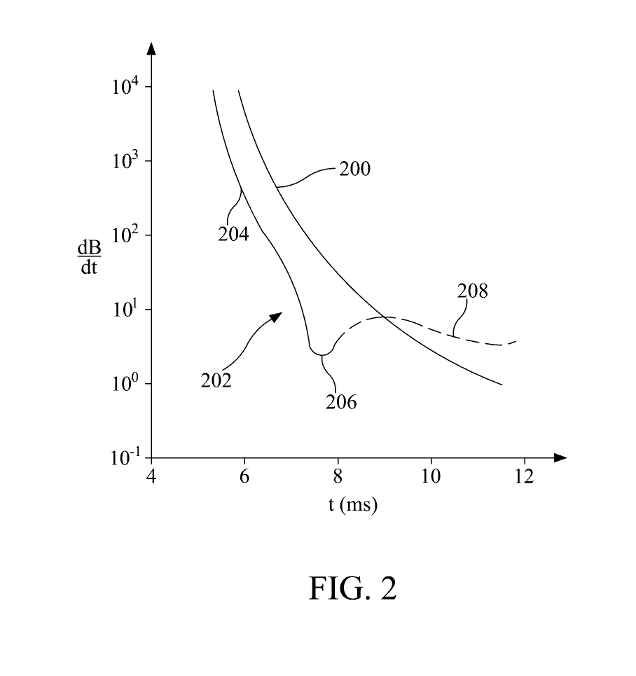

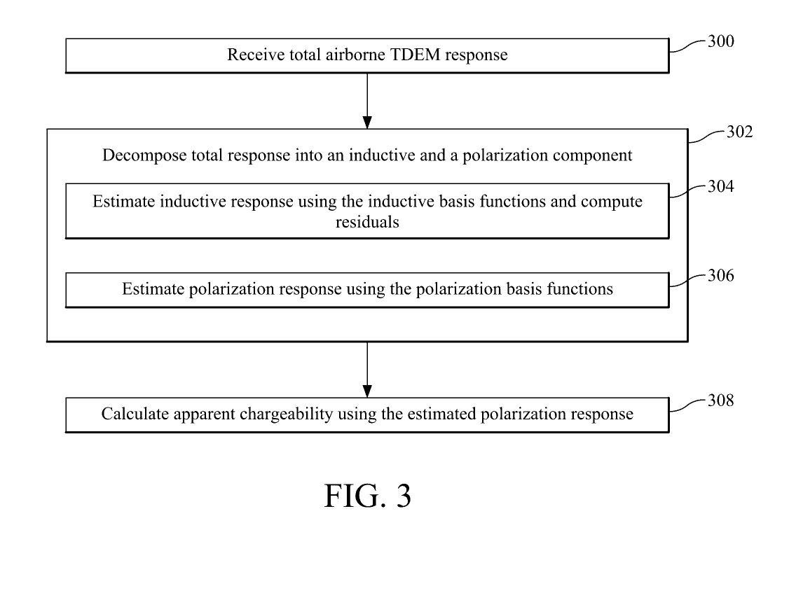

A first method for calculating the IP effect from airborne TDEM data is now discussed with reference to FIG. 3. The transmitter in the TDEM survey generates an electric field in the ground, which results in an induction current. The electric field and induction current generate the polarization current, which is opposite in direction (polarity) to the electric field and induction current. In areas with no polarizable regions, there is no polarization current and thus, only the classic induction decay curve 200 as illustrated in FIG. 2 is measured. The induction decay response of a central-loop vertical receiver always has positive polarity and has negative slope. As previously discussed, an IP response would have opposite polarity to that of the induction response.

Over polarizable ground, the TDEM system measures the combined response (termed herein “total” response) from the inductive current and the polarization current. If the polarization current is large compared to the induction current, and because the polarization current is opposite to the induction current, the total response amplitude may become negative at some time and the polarization response is easily identified. Depending on the relative strength of the two components, the total response decay may or may not contain a negative response.

In the embodiment illustrated in FIG. 3, the measured total signal is measured or received in step 300. The known excitation signal is also received in step 300. The measured total signal and the known excitation signal are used in step 302 to decompose the total response into an inductive and a polarization component. Step 302 may be performed in two sub-steps or stages. In sub-step 304, the measured (total) EM response is used to obtain the inductive response (e.g., as is done in regular EM induction methods) by fitting the inductive basis functions computed as described in the next paragraph. The residual is calculated by subtracting the estimated (fitted) inductive response from the total response. In sub-step 306, the polarization response is obtained by fitting polarization basis functions to this residual. In step 308, the chargeability is calculated based on the polarization response.

Sub-step 304 is now discussed in more detail. The inductive response may be estimated as follows. The response of a time domain EM system can be expressed as a linear equation:

$$A α = d , \\ or \\ [ \begin{matrix}a ( {t}_{1} , {τ}_{1} ) & … & a ( {t}_{1} , {τ}_{n} ) \\ ⋮ & ⋱ & ⋮ \\ a ( {t}_{m} , {τ}_{1} ) & … & a ( {t}_{m} , {τ}_{n} )\end{matrix} ] [ \begin{matrix}{α}_{1} \\ ⋮ \\ {α}_{n}\end{matrix} ] = [ \begin{matrix}{d}_{1} \\ ⋮ \\ {d}_{m}\end{matrix} ] , \qquad ( 1 )$$

where A is an (m×n) matrix with its elements a(tᵢ,τⱼ), (i=1, . . . , m; j=1, . . . , n) being the value of the basis function associated with the inductive time constant τⱼ at time tᵢ (the central time of sampling window). The basis functions are calculated by convolving the transmitter's primary waveform sampled at the receiver with pure exponential decays of discrete time constants (τ₁, . . . , τₙ). In equation (1), α is the n×1 coefficient vector to be estimated, and d is the m×1 data vector that contains the total EM response measured at m channels.

In this embodiment, a non-negative least square algorithm, which ensures that only induction response is fitted, is used to solve linear equation (1) to estimate a. The inductive response (d) is calculated by employing positivity constraints when solving equation:

\hat{d}=A\hat{α}, (2)

where \hat{α} is the estimated coefficient vector. The residual, which may or may not contain the polarization response, is given by:

r=d−\hat{d}. (3)

The polarization response in sub-step 306 may be estimated as follows. The residual (r) from the inductive response fitting will contain the polarization response, if the region is polarizable. Similarly, the residual can also be expressed as a linear equation:

$$B β = r , \\ or as \\ [ \begin{matrix}b ( {t}_{1} , {τ}_{1} ) & … & b ( {t}_{1} , {τ}_{n} ) \\ ⋮ & ⋱ & ⋮ \\ b ( {t}_{m} , {τ}_{1} ) & … & b ( {t}_{m} , {τ}_{n} )\end{matrix} ] [ \begin{matrix}{β}_{1} \\ ⋮ \\ {β}_{n}\end{matrix} ] = [ \begin{matrix}{r}_{1} \\ ⋮ \\ {r}_{m}\end{matrix} ] , \qquad ( 4 )$$

where B is a (m×n) matrix, its elements being b(tᵢ, τⱼ), (i=1, . . . , m; j=1, . . . , n), the value of the polarization basis function associated with inductive time constant τⱼ at time tᵢ (the central time of sampling window). The polarization basis functions are calculated by convolving the inductive basis functions with the polarization impulse response of a certain chargeability and polarization time constant (for example chargeability of 0.5 and polarization time constant 1.5 ms). The Warburg model of the Cole-Cole relaxation equation is used and this limits the frequency dependent factor c=½; β is the n×1 coefficient vector to be estimated, and r is the m×1 residual vector calculated based on equation (3). Optionally, different frequency dependent factors can be used to generate the basis functions. The Warburg model is used here because the solutions are analytic.

Again, using the non-negative least squares constraint, to ensure that only the polarization response is fitted, the coefficient vector \hat{β} is estimated and the estimated polarization response is given by:

p=B\hat{β}. (5)

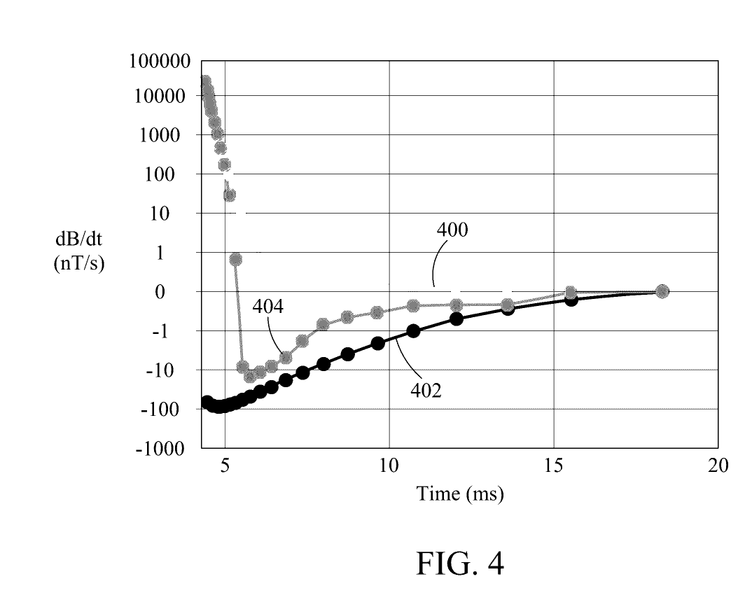

FIG. 4 shows an example of the two-stage process illustrated in regard to FIG. 3. The total EM response 404 is decomposed into an inductive component 400 and an IP component 402 using the mathematical formalism noted above.

After the polarization response has been estimated, the apparent chargeability can be estimated by calculating the area under the polarization response curve: mₐₚₚ=Σᵢ₌₁ⁿpᵢTᵢ, where mₐₚₚ is the apparent chargeability, n is the total number of off-time channels, and pᵢ and Tᵢ are the estimated polarization and channel width of channel i, respectively.

An alternative way of calculating the polarization basis functions is by convolving the estimated inductive response with the polarization impulse response over a range of polarization time constants and chargeability values. The polarization response can be estimated by determining which single decay curve from this set of basis functions best fits the residual. The polarization parameters, e.g., polarization time constant and chargeability, of the best-fitting curve is kept as the polarization properties of the ground at the measurement location. Or, the residual can be fit using the polarization basis functions and the polarization properties estimated by using a weighted average of the chargeability and polarization time constants. Lateral constraints can also be applied during the fitting process to increase the stability of the algorithm.

In an alternative embodiment, the algorithm discussed above provides a polarization decay defined by an apparent chargeability and a polarization time constant.

One strength of this algorithm is that the decomposition process allows separation of the IP response from the total response even if the total response does not become negative (i.e., the algorithm is able to identify the IP response even if it would be difficult for a person to identify it). The above algorithm also provides robust ways of subtracting IP information from total TDEM response and estimate the apparent chargeability over polarizable earth.

Another method for calculating the IP response is now discussed. This method uses a ratio algorithm to estimate the ground chargeability and normalizes the measured IP response by the measured inductive response rather than by the primary excitation as done in ground IP surveying.

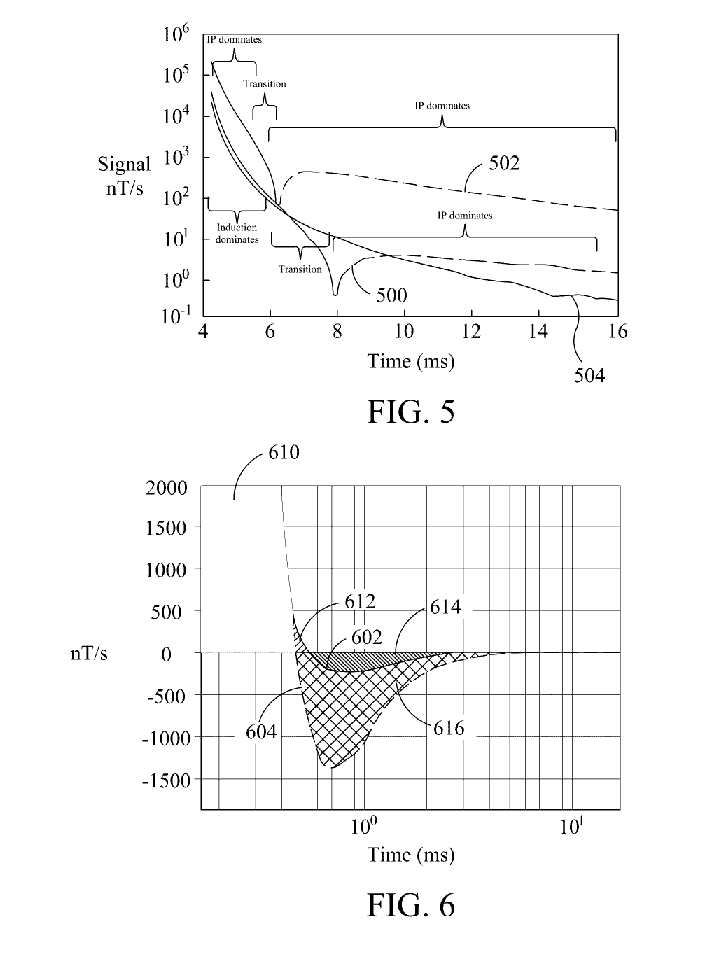

As already discussed above, in EM surveys, the IP response is generally identified when the measured signal contains a reversal. FIG. 5 compares modelled layered earth response from an airborne EM system when the ground is polarizable (curves 500 and 502) to the case where no polarizable region is present (curve 504). The response from the polarizable ground shows a negative (changed polarity or a reversal denoted by dashed lines in the figure) in the signal while the response from non-polarizable ground does not. This change in polarity allows discrimination between inductive response (positive) and IP response (signal reversal). Note that there is also a transition region, where the total response signal is dominated by neither the inductive nor the IP response.

While line 504 is for a layered earth with no polarizable material, line 500 is for a layered earth with a thin polarizable overburden with chargeability m of 0.25, and line 502 is for a layered earth with polarizable overburden with chargeability of 0.75. In this logarithmic scale a solid line indicates a positive amplitude while a dashed line indicates a negative-amplitude.

There are numerous ways to specify the amplitude of the induction portion of the response and the IP portion of response. The IP response amplitude can be identified/defined as the maximum negative signal amplitude. Alternatively, the IP response can be computed as the time-integral of the portions of the measured signal where the response is negative, as shown, for example, in FIG. 6.

The induction response can be identified/defined as the maximum positive signal, or the time-integral of positive portions of the measured response, or, in systems measuring during the on-time of the primary field, estimated as the measured secondary signal when the primary induction changes quickly. In areas of low off-time signal amplitude, it may be difficult to accurately identify the induction response. However, during the on-time, when the primary field is changing quickly (such as when the transmitter current increases or decreases quickly), the on-time secondary response can be large and an inductive response identified.”

In some cases, identifying whether or not the IP response is present may be difficult. Since the physics of center-loop EM systems results in the slope of the decay curve always being negative when polarization effects are absent, the IP response can be identified by calculating the slope of the response curve at different points along the curve and looking for a positive slope. The time where the slope changes sign gives an indication that an IP response is present. The amplitude of the IP response can then be estimated by fitting a decay curve to the negative-sloping (inductive) portion of the measured signal and extrapolating through the identified IP response; the IP response can then be estimated as the difference between the measured signal and the fitted curve at the identified IP response time.

The basis for determining the IP response is recognizing that the EM induction effect causes a current to flow in the ground and this current leads to polarization charges developing in a polarizable body. The amount of polarization current is estimated by using the measured EM induction response (note that the imposed electric field can also lead to polarization charges). This is in contrast with the classic ground IP procedure, which uses the applied primary voltage as a normalization factor. According to this embodiment, the inventors have discovered that the chargeability from airborne TDEM data may be calculated by estimating the IP response and normalizing it by the induction response.

Alternatively, in another embodiment, it is possible to use a known method for identifying the amplitude of the IP response to create a grid, which is a useful tool for discriminating chargeable material. According to this embodiment, the method does not employ any normalization term.

There are a number of possible variants of the algorithm discussed above. For example, the IP response can be better estimated by first removing the inductive portion of the measured signal, before examining the signal for IP effect. This approach is preferred in cases where the IP effect is not strong enough to drive the total response to be negative. The background inductive response can be estimated by inversion (assuming zero IP response) or by fitting time constants to the portions of the decay curve which have negative slope.

A possible algorithm to estimate chargeability m based on the ratio of the IP response to the inductive response is now discussed in more detail. The chargeability estimation is given by:

$${m}_{AIP} = - \frac{\int {V}_{IP} d t}{\int {V}_{EM} d t} \qquad ( 6 )$$

where m_{AIP} is the airborne induced polarization chargeability to be estimated, V_{IP} is the negative response measured by the receiver, and the integral ∫ V_{IP}dt is the area made by the negative decays 502;
the denominator ∫ V_{EM}dt is the area formed by positive EM induction responses V_{EM} 500, including the on-time area 614. In one application, it is possible to have an algorithm for estimating the chargeability for which the on-time is excluded.

In some environments, the geology may result in an electromagnetic induction response that is negative at early off-times; for these situations, the inclusion of the on-time is necessary. This can be accomplished by adding measured on-time secondary response to the denominator of equation (6). The on-time secondary response will be dominated by inductive effects and thus, it is useful as a normalization factor.

In one embodiment, equation (6) can be implemented for a discrete-channel EM system. For this situation, equation (6) can be expressed as:

$${m}_{AIP} = - \frac{{\sum }_{i} {V}_{IP} ( i ) Δ T ( i )}{{V}_{EM} ( 0 ) Δ T ( 0 ) + {\sum }_{j} {V}_{EM} ( j ) Δ T ( j )} \qquad ( 7 )$$

where ΔT(i) is the width of channel i in milliseconds; ΣₜV_{IP} (i)ΔT(i) is the area estimated by channeled IP effect response, V_{EM}(0)ΔT(0) is the first on-time response multiplied by its channel width, and ΣⱼV_{EM}(j)ΔT(j) is the summation of the off-time response due to the EM inductive response. The unit of the estimated chargeability is dimensionless and often converted to be a percentage.

Equation (7) estimates the chargeability by normalizing the IP response. Similarly, one could identify chargeable material simply by calculating the IP response without the conductive normalization (denominator of equation (7)).

FIG. 6 provides a graphical illustration of how equation (7) can be applied; the figure shows the response curves 602 and 604 for two different chargeability values, 0.25 and 0.75 respectively. Area 610 under the positive portion of the measured signal is the induction portion of the decay curve for the 0.75 chargeability curve 604. The induction portion of the 0.25 chargeability curve 602 is the area formed by the area 610 plus the area 612. The IP response area 614 is shown for the 0.25 chargeability curve 602 and the IP area 614 and 616 are shown for the 0.75 chargeability curve 604.

The methods discussed above used different quantities for normalizing the IP response. According to an embodiment, it is possible to normalize the induction response by the estimated electric field in the ground. This method is now discussed in more detail.

Conventional ground IP uses the applied potential field, which is the excitation signal, as the normalization factor for chargeability. In this embodiment, the inventors propose to use the EM induction source excitation signal, which is the electric field in the ground, as the normalization factor for the airborne IP chargeability calculation.

The equation for an electric field in a layered earth due to a large wire loop is well known, and thus not repeated herein. To estimate the electric field generated by the EM system into the ground, the excitation signal, transmitter to ground coupling, and conductivity and magnetic permeability of the ground need to be known or estimated. This embodiment assumes that the relative magnetic permeability of the ground is 1 and the on-time measurements from the EM system are used to estimate the conductivity of the ground. This is commonly done in processing and interpretation of airborne EM surveying and numerous techniques exist for doing this. The estimate of the ground conductivity (either a simple half-space conductivity, or layered conductivity, or 2-D or 3-D conductivity distribution), knowledge of the position of the EM transmitter relative to the ground and knowledge of the excitation signal are necessary to compute the electric field in the ground. It is this electric field that generates polarization charges in polarizable material, eventually resulting in the polarization response. With this information, the polarization response is normalized by the computed electric field to obtain the chargeability of the ground.

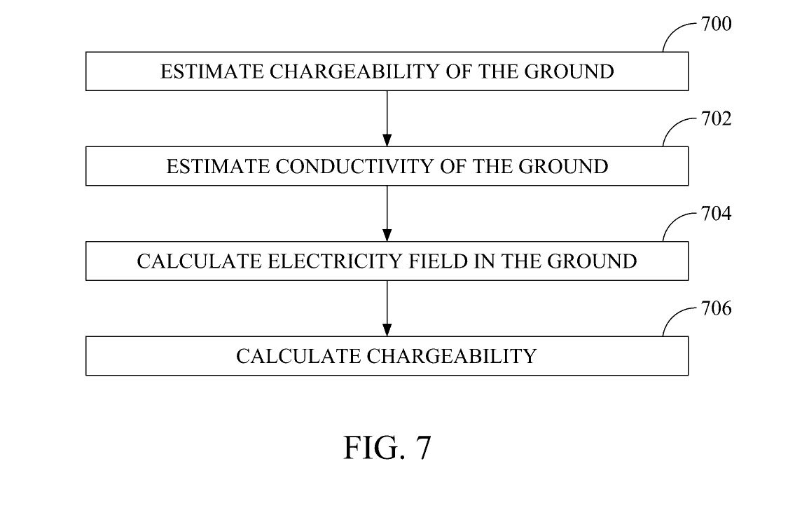

A method for normalizing the IP response as discussed in this embodiment is illustrated in FIG. 7. In step 700, the polarization response is estimated. The polarization response may be estimated at each point of interest on the map. Other measures may be used. In step 702, the conductivity of the ground is estimated using the on-time secondary response. In step 704, the electric field in the ground is calculated based on the estimated conductivity. In step 706, the chargeability is calculated as the ratio of the polarization response from step 700 and the electric field in the ground calculated in step 704.

While the previous embodiments have presented some novel methods for calculating the IP effect, the next embodiment is focused on determining the existence of polarizable regions underground, which will be an indicator of chargeability. Thus, in one embodiment, the method to be presented does not effectively calculate the chargeability, but only provides a qualitative indication of chargeability. However, this method can be combined with the previously discussed novel algorithms or with known algorithms for also calculating the chargeability.

According to this method, a change in the slope of a time constant along a measured decay curve is calculated. The measured decay curve is the total response discussed above, i.e., the sum of the induction response and the IP response. More specifically, the chargeability calculated based on airborne TDEM data is characterized by the negative response relative to the polarity of the induction response. However, in areas of high conductivity and/or low chargeability, there may be no negative part to the decay curve. The inventors of this application have observed that for these areas, there is an exceptionally fast decay of the decay curve. Example of decay curves 500, 502 and 504 have been illustrated in FIG. 5.

The exponential decay constant is defined by

$$τ = \frac{- ( {t}_{n} - {t}_{n - a} )}{log ( \frac{\frac{d B}{d {t}_{n}}}{\frac{d B}{d {t}_{n - a}}} )} ,$$

where dB/dt are data amplitudes, t is the measurement time, and n and n-a represent two channels at different times. Any two times on the decay curve can be used.

Chargeability can be detected where the decay constant τ is abnormally low, e.g., too low to be the response of resistive geology. For example, the decay constant 10-20 μs after a pulse can be on the order of 10 μs on ground of 10,000 ohm-m resistivity, and 35 μs on ground of 10 ohm-m resistivity. This decay slows to 100 μs or more at 200 μs after the pulse.

If high numbers are preferred for anomalous areas of interest, the inverse decay constant can be used instead of the decay constant, and the inverse decay constant is defined by:

$$i τ = \frac{- log ( \frac{\frac{d B}{d {t}_{n}}}{\frac{d B}{d {t}_{n - a}}} )}{( {t}_{n} - {t}_{n - a} )}$$

$$or by$$

$$i τ = \frac{1}{τ} .$$

It is generally beneficial if the offset ‘a’ between the two time channels is greater than one, and it can be any number equal to or greater than 1.

The decay constant, and inversion decay constant can also be calculated using a power-law decay, for example:

$$p τ = \frac{- log ( {t}_{n} / {t}_{n - a} )}{log ( \frac{\frac{d B}{d {t}_{n}}}{\frac{d B}{d {t}_{n - a}}} )}$$

or the inverse decay constant given by:

$$ip τ = \frac{- log ( \frac{\frac{d B}{d {t}_{n}}}{\frac{d B}{d {t}_{n - a}}} )}{log ( {t}_{n} / {t}_{n - a} )} .$$

A weak chargeability can be detected by measuring the time derivative (or rate-of-decay) of the decay constant, which is given by:

$$\frac{d τ}{d t} = \frac{{t}_{n} - {t}_{n - a}}{{t}_{n} - {t}_{n - a}} .$$

The rate-of-decay will normally be positive for the decay curve over a layered or homogeneous conductive earth, but unusually low, zero, or negative when chargeable regions are present.

In all the cases described above for calculating the decay constant, inverse decay constant, and time-derivative of decay constant, for exponential decay or power-law decay, the time derivative of the magnetic field (dB/dt) has been used as an example. However, the time derivative of the magnetic field can be substituted with the magnetic field (B-field) or another quantity representative of the magnetic field, for each equation noted above. This means that an airborne TDEM survey needs to record the magnetic field, or its time derivative or any other quantity related to the magnetic field so that the above methods can be used for calculating the decay constant, inverse decay constant, and/or time-derivative of decay constant.

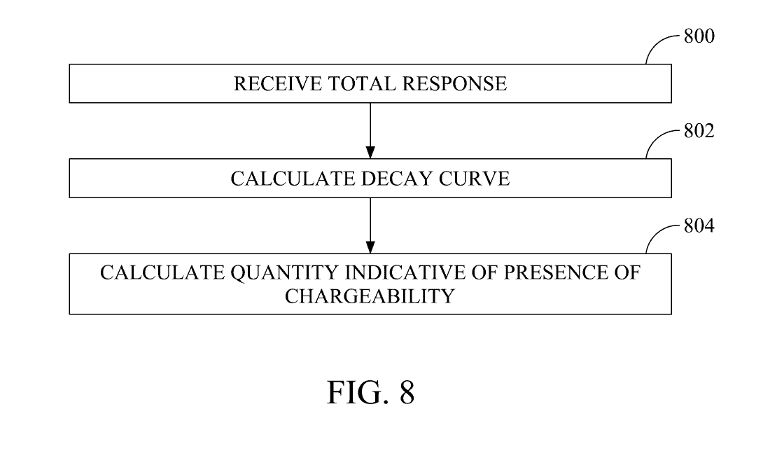

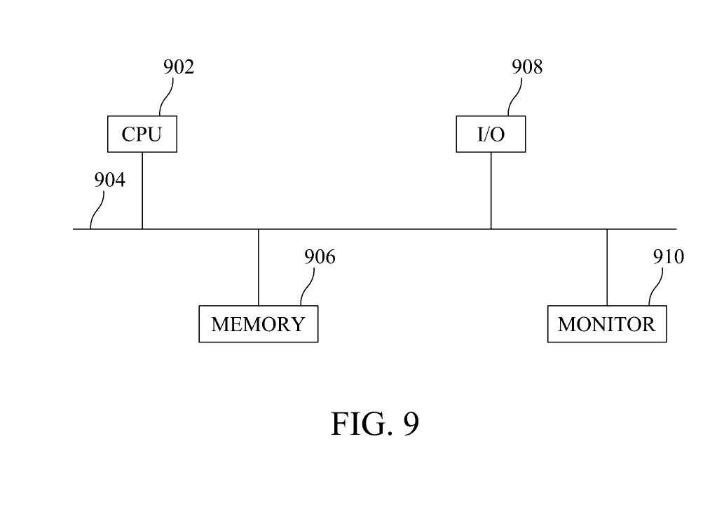

A method for determining and identifying the chargeability of an underground formation is now discussed with regard to FIG. 8. The method includes a step 800 of receiving a total response of the underground formation from an airborne time domain electromagnetic (TDEM) survey system, a step 802 of calculating a decay curve associated with the total response, and a step 804 of calculating a quantity associated with the decay curve that indicates presence of chargeable material in the underground formation.

As also will be appreciated by one skilled in the art, the embodiments discussed above may be embodied in a processing unit 900 as illustrated in FIG. 9. Processing unit 900 includes a processor 902 that is connected through a bus 904 to a storage device 906. Processing unit 900 may also include an input/output interface 908 through which data can be exchanged with the processor and/or storage device. For example, a keyboard, mouse or other device may be connected to the input/output interface 908 to send commands to the processor and/or to collect data stored in storage device or to provide data necessary to the processor. In one application, the processor calculates the position and orientation of composite EM system. Also, the processor may be used to process, for example, the signals collected during the survey. Results of this or another algorithm may be visualized on a screen 910. The method discussed above may be implemented in a wireless communication device or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such as a floppy disk or magnetic tape. Other non-limiting examples of computer-readable media include flash-type memories or other known types of memories.

This written description uses examples of the subject matter disclosed to enable any person skilled in the art to practice the same, including making and using any devices or systems and performing any incorporated methods. For greater clarity, the figures used to help describe the invention are simplified to illustrate key features. For example, figures are not to scale and certain elements may be disproportionate in size and/or location. Furthermore, it is anticipated that the shape of various components may be different when reduced to practice, for example. The patentable scope of the subject matter is defined by the claims, and may include other examples that occur to those skilled in the art. Such other examples are intended to be within the scope of the claims. Those skilled in the art would appreciate that features from any embodiments may be combined to generate a new embodiment.

The disclosed embodiments provide a method and device for determining an IP response of a surveyed subsurface. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for estimating an apparent chargeability of a surveyed underground formation, the method comprising:
receiving a total response of the underground formation from an airborne time domain electromagnetic (TDEM) survey system;
separating, in two stages, the total response into an inductive response and an induced polarization response; and
calculating the apparent chargeability based on the induced polarization response.

2. The method of claim 1, further comprising:
calculating a fitting response of the total response using a series of pure-inductive decays to obtain the inductive response; and
calculating a residual between the total response and the fitting response.

3. The method of claim 2, wherein the inductive decays are exponentials or power law decay models.

4. The method of claim 2, further comprising:
calculating the induced polarization response by fitting pure-polarization functions to the residual.

5. The method of claim 2, further comprising:
fitting the residual with a range of polarization functions and estimating the apparent chargeability and polarization time constant by a weighted average of the polarization basis functions, weighted according to the estimated fitting coefficients.

6. The method of claim 4, wherein the induced polarization response is selected to be pure-polarization function that fits best the residual, thus obtaining an estimate of an induced polarization time constant and the apparent chargeability, and a frequency factor c.

7. The method of claim 4, wherein the induced polarization response is used to estimate the apparent chargeability.

8. The method of claim 7, wherein the apparent chargeability is estimated by calculating an area under the polarization response curve by summing the amplitude of polarization response, or summing polarization amplitude times the time-width of the channel, or through an inversion process, or using the polarization properties of the best-fitting polarization function.

9. The method of claim 4, wherein the induced polarization response or calculated/estimated chargeability is mapped or gridded.

10. The method of claim 1, further comprising:
calculating the apparent chargeability by normalizing the induced polarization response with an electric field in earth, wherein the electric field in earth is induced by the airborne TDEM survey system.

11. The method of claim 10, wherein the electric field in earth is calculated based on properties of a transmitter and receiver of the airborne TDEM survey system, and a conductivity of the earth.

12. A computing device for estimating a chargeability of an underground formation, the computing device comprising:
an interface that receives a total response of the underground formation from an airborne time domain electromagnetic survey system; and
a processor connected to the interface and configured to,
receive a total response of the underground formation from an airborne time domain electromagnetic (TDEM) survey system;
separate, in two stages, the total response into an inductive response and an induced polarization response; and
calculate the apparent chargeability based on the induced polarization response.

13. The device of claim 12, wherein the processor is further configured to:
calculate a fitting response of the total response using a series of pure-inductive decays to obtain the inductive response; and
calculate a residual between the total response and the fitting response.

14. The device of claim 13, wherein the inductive decays are exponentials or power law decay models.

15. A method for identifying a chargeability of an underground formation, the method comprising:
receiving a total response of the underground formation from an airborne time domain electromagnetic (TDEM) survey system;
calculating a decay curve associated with the total response; and
calculating a quantity associated with the decay curve that indicates a presence of the chargeability of the underground formation.

16. The method of claim 15, wherein the quantity is an exponential decay constant.

17. The method of claim 16, wherein the exponential decay constant is in the order of tens or thousands of micro seconds in the presence of the chargeable underground formation.

18. The method of claim 15, wherein the quantity is an inverse exponential decay constant.

19. The method of claim 15, wherein the quantity is a time rate-of-decay of the computed decay constants.

20. The method of claim 15, wherein the quantity is a function of the magnetic field or the time-derivative of the magnetic field and an exponential or power law governs the decay of the quantity.
